(19) United States
(12) Patent Application Publication
(10) Pub. No.: US 2024/0321276 A1
(43) Pub. Date: Sep. 26, 2024

(54) ELECTRONIC DEVICE FOR PERFORMING VOICE RECOGNITION BY USING RECOMMENDED COMMAND

(71) Applicant: SAMSUNG ELECTRONICS CO., LTD., Suwon-si (KR)

(72) Inventors: Chansik BOK, Suwon-si (KR); Chanhee CHOI, Suwon-si (KR)

(73) Assignee: SAMSUNG ELECTRONICS CO., LTD., Suwon-si (KR)

(21) Appl. No.: 18/731,809

(22) Filed: Jun. 3, 2024

Related U.S. Application Data
(63) Continuation of application No. PCT/KR2022/017395, filed on Nov. 8, 2022.

(30) Foreign Application Priority Data
Dec. 8, 2021 (KR) 10-2021-0174444

(51) Int. Cl. G10L 15/22; G10L 15/28

(52) U.S. Cl. CPC G10L 15/22; G10L 15/28; G10L 2015/223

(57) ABSTRACT

Disclosed is an electronic device for performing voice recognition by using a recommended command. The electronic device according to various embodiments may include: a processor; an input module for receiving a voice input from a user; and a memory electrically connected to the processor and storing an instruction executable by the processor, a client module, and a recommended command, wherein the processor: determines whether domains of a plurality of plans, which are consecutively generated according to a command included in the voice input, are identical to each other by a configured number or more; when the domains are identical to each other, determines the recommended command on the basis of the domains and stores the recommended command in the memory; and executes the client module on the basis of the plans generated according to the recommended command.

### CROSS-REFERENCE TO RELATED APPLICATIONS

This application is a continuation of International Application No. PCT/KR2022/017395, filed Nov. 8, 2022, and claims foreign priority to Korean Application No. 10-2021-0174444, filed Dec. 8, 2021, which are incorporated herein by reference in their entireties.

### TECHNICAL FIELD

The disclosure relates to an electronic device for performing speech recognition using a recommended command. More specifically, the electronic device for performing speech recognition using a recommended command may determine a recommended command when an action is performed according to successive utterances of the same domain, and perform speech recognition when a user utters the recommended command without uttering a wake-up word.

### BACKGROUND ART

With the advancement of speech recognition technology, many electronic devices provide speech recognition functions, allowing various devices to be controlled from a distance through speech recognition.

To control a device through speech recognition from a distance, the device performs speech recognition only when a command is uttered after a wake-up word, for example, an utterance such as “Hi, XXX”, “OK, YYY”, “ZZZ”, or the like to input the command in voice.

Recently, concurrent wake up technology for recognizing several wake-up word utterances in one device has been developed, allowing a plurality of wake-up word utterances to be recognized concurrently.

### DISCLOSURE OF THE INVENTION

### Technical Solutions

In using conventional speech recognition technology, when a user uses speech recognition several times within a short period of time, the user needs to utter a wake-up word each time, which may cause inconvenience to the user. For example, when a user watching TV consecutively utters “HI XXX, channel A”, “HI XXX, channel B”, “HI XXX, channel C”, and the like to find channels, the user needs to utter a wake-up word such as “HI XXX” each time even when continuously uttering channel names in the same domain.

Since a wake-up word needs to be uttered each time even when continuously uttering voice inputs related to actions of the same type, for example, commands belonging to the same domain, the user may experience inconvenience, and the cost of processing the received voice inputs may increase.

According to various embodiments disclosed herein, an electronic device for performing speech recognition using a recommended command may determine a recommended utterance or a recommended command by analyzing a predicted utterance of a user and perform speech recognition using a recommended command uttered by a user without a set wake-up word using concurrent wake up technology.

According to various embodiments disclosed herein, an electronic device for performing speech recognition using a recommended command may match a determined recommended command to a set recommended wake-up word, and perform speech recognition using a recommended wake-up word uttered by a user.

An electronic device according to various embodiments may include an input module configured to receive a voice input from a user, a memory storing instructions, and processor configured to execute the instructions to determine whether domains of a plurality of plans consecutively generated according to a command included in the voice input are identical by a preset number or more, store a recommended command obtained based on the domains in the memory, when the domains are identical by the preset number or more, and control a client module to be executed based on a plan generated according to the recommended command.

According to various embodiments, the client module may be configured to generate the plan corresponding to the voice input when identifying the recommended command or a wake-up word preceding the command included in the voice input.

According to various embodiments, the processor may be configured to execute the instructions to identify the user using the voice input, and obtain the recommended command based on information about the user and the domains.

According to various embodiments, the processor may be configured to execute the instructions to delete the stored recommended command when the recommended command is not input from the user within a preset time.

According to various embodiments, the processor may be configured to execute the instructions to match the recommended command to a recommended wake-up word, and the client module may be configured to identify the recommended wake-up word included in the voice input, and generate the plan according to the recommended command corresponding to the recommended wake-up word.

According to various embodiments, the processor may be configured to execute the instructions to output the recommended command and the recommended wake-up word to a display module.

According to various embodiments, the electronic device may further include a natural language platform configured to process the voice input and generate the plan.

According to various embodiments, the processor may be configured to execute the instructions to determine whether the user who utters the voice input comprising the command is identical to a user who utters a voice input comprising the recommended command.

An electronic device according to various embodiments may include an input module configured to receive a voice input from a user, a client module configured to generate a plan according to the voice input when identifying a recommended command or identifying a wake-up word to start speech recognition from the voice input, and a processor configured to determine whether domains of plans consecutively generated according to a command following the wake-up word included in the voice input are identical by a preset number or more, store the recommended command related to a predicted utterance of the user, when the domains are identical by the preset number or more, and control the client module to be executed based on a plan generated according to the recommended command.

According to various embodiments, the processor may be configured to identify the user using the voice input, and obtain the recommended command based on information about the user and the domains.

According to various embodiments, the processor may be configured to delete the stored recommended command when the recommended command is not input from the user within a preset time.

According to various embodiments, the processor may be configured to match the recommended command to a recommended wake-up word, and the client module may be configured to identify the recommended wake-up word included in the voice input, and generate the plan according to the recommended command corresponding to the recommended wake-up word.

According to various embodiments, the processor may be configured to output the recommended command and the recommended wake-up word to a display module.

An electronic device according to various embodiments may include a front end configured to receive a voice input from a user terminal and transmit a response corresponding to the voice input to the user terminal, and a natural language platform configured to process the voice input and generate a plan corresponding to the voice input, wherein the natural language platform may determine whether domains of plans consecutively generated are identical by a preset number or more, and store a recommended command obtained based on the domains when the domains are identical by the preset number or more, and the user terminal may transmit the voice input to the front end when the voice input includes a wake-up word to start speech recognition or the recommended command.

According to various embodiments, the natural language platform may be configured to match the recommended command and a plan according to the recommended command, and generate a plan according to the recommended command when the recommended command is input.

### Effects of the Invention

According to various embodiments disclosed herein, an electronic device may provide a user with a recommended command that is expected to be input by the user according to a voice input received from the user, and perform speech recognition by inputting only the recommended command without uttering a wake-up word, thereby providing user convenience.

According to various embodiments disclosed herein, an electronic device may perform speech recognition using a recommended command, thereby reducing the usage of resources to perform an action necessary for speech recognition.

### BRIEF DESCRIPTION OF DRAWINGS

FIG. 1 is a block diagram of an electronic device in a network environment according to various embodiments.

FIG. 2 is a block diagram illustrating an integrated intelligence system according to an embodiment.

FIG. 3 is a diagram illustrating a form in which relationship information between concepts and actions is stored in a database according to various embodiments.

FIG. 4 is a diagram illustrating a screen of a user terminal processing a received voice input through an intelligent app according to various embodiments.

FIGS. 5A and 5B are diagrams illustrating a screen of an electronic device processing a received voice input through an intelligent app according to various embodiments.

FIGS. 6A and 6B are diagrams illustrating a screen of an electronic device processing a received voice input through an intelligent app according to various embodiments.

FIG. 7 is a diagram illustrating an operation of determining a recommended command using a voice input by an electronic device according to an embodiment.

FIG. 8 is a diagram illustrating an operation of determining a recommended command and recognizing the recommended command by an electronic device according to an embodiment.

FIGS. 9A and 9B are diagrams illustrating an operation of generating a plan according to a received voice input by an electronic device according to an embodiment.

FIGS. 10A, 10B, and 10C are diagrams illustrating wake-up words, recommended wake-up words, and recommended commands stored in a memory of an electronic device according to an embodiment.

FIG. 11 is a diagram illustrating recommended wake-up words and recommended commands output to a display module of an electronic device according to an embodiment.

FIGS. 12A and 12B are diagrams illustrating recommended wake-up words and recommended commands output to a display module of an electronic device or a display module of an external electronic device according to an embodiment.

### BEST MODE FOR CARRYING OUT THE INVENTION

Hereinafter, embodiments will be described in detail with reference to the accompanying drawings. When describing the embodiments with reference to the accompanying drawings, like reference numerals refer to like components, and any repeated description related thereto will be omitted.

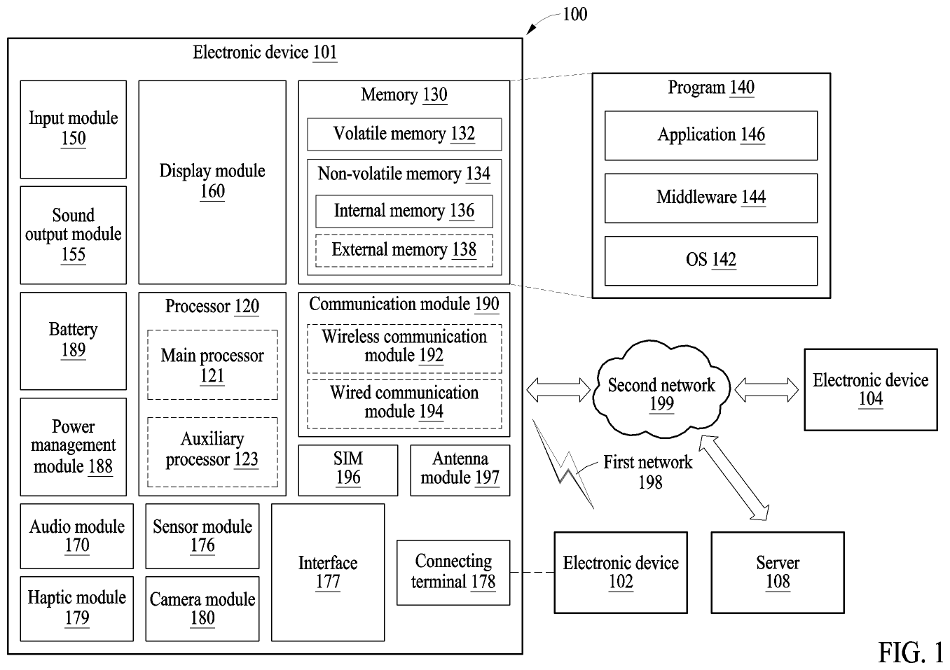

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a portion of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which an artificial intelligence model is executed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted aturaln machine (RBM), a deep belief network (DBN), and a bidirectional recurrent deep neural network (BRDNN), a deep Q-network, or a combination of two or more thereof, but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146. The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to various embodiments, the antenna module 197 may form a mmWave antenna module. According to an embodiment, the mm Wave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more of the external electronic devices 102 and 104, and the server 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least portion of the function or the service requested, or an additional function or an additional service related to the request, and may transfer an outcome of the performing to the electronic device 101. The electronic device 101 may provide the outcome, with or without further processing of the outcome, as at least portion of a reply to the request. To that end, a cloud computing, distributed computing, mobile edge computing (MEC), or client-server computing technology may be used, for example. The electronic device 101 may provide ultra low-latency services using, e.g., distributed computing or MEC. In one embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

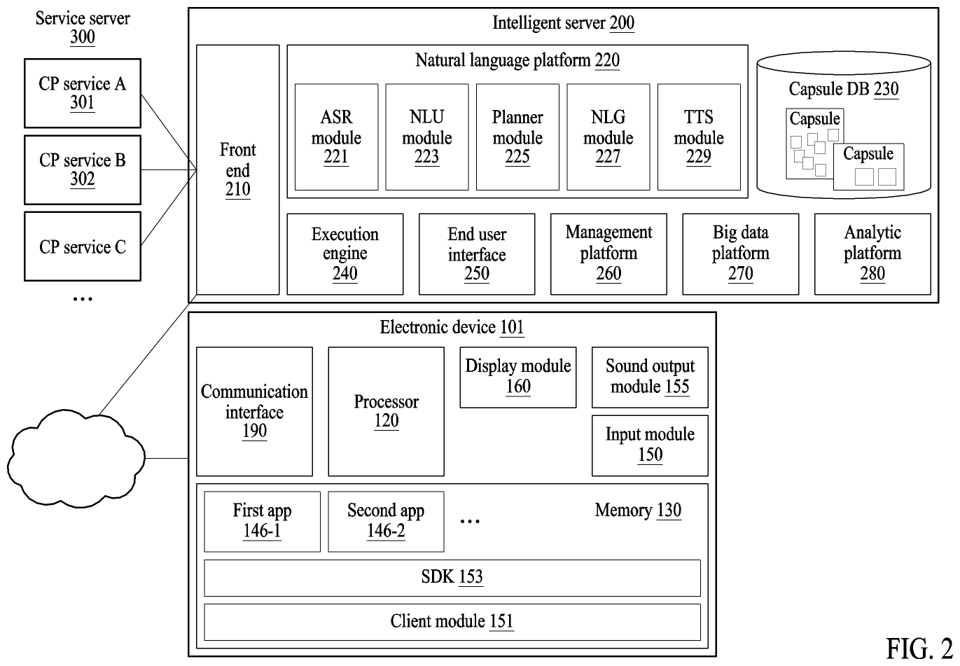

FIG. 2 is a block diagram illustrating an integrated intelligence system according to an embodiment.

Referring to FIG. 2, an integrated intelligence system 10 according to an embodiment may include a user terminal 101, an intelligent server 200, and a service server 300.

The user terminal 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the shown embodiment, the user terminal 101 may include the communication module 190, the input module 150, the sound output module 155, the display module 160, the memory 130, or the processor 120. The components listed above may be operationally or electrically connected to each other.

The communication module 190 may be connected to an external device and configured to transmit and receive data to and from the external device. The input module 150 may receive a sound (e.g., a user utterance) and convert the sound into an electrical signal. The sound output module 155 may output the electrical signal as a sound (e.g., a speech). The display module 160 may be configured to display an image or video. The display module 160 may also display a graphical user interface (GUI) of an app (or an application program) being executed.

The memory 130 may store a client module 151, a software development kit (SDK) 153, and a plurality of apps 146. The client module 151 and the SDK 153 may configure a framework (or a solution program) for performing general-purpose functions. In addition, the client module 151 or the SDK 153 may configure a framework for processing a voice input.

The plurality of apps 146 may be programs for performing designated functions. The plurality of apps 146 may include a first app 146_1, a second app 146_2, and the like. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the user terminal 101. For example, the processor 120 may be electrically connected to the communication module 190, the input module 150, the sound output module 155, and the display module 160 to perform a designated operation.

The processor 120 may also perform the designated function by executing the program stored in the memory 130. For example, the processor 120 may execute at least one of the client module 151 or the SDK 153 to perform the following operation for processing a voice input. The processor 120 may control the operation of the plurality of apps 155 through, for example, the SDK 153. The following operation which is the operation of the client module 151 or the SDK 153 may be performed by the processor 120.

The client module 151 may receive a voice input. For example, the client module 151 may receive a voice signal corresponding to a user utterance sensed through the input module 150. The client module 151 may transmit the received voice input to the intelligent server 200. The client module 151 may transmit state information of the user terminal 101 together with the received voice input to the intelligent server 200. The state information may be, for example, execution state information of an app.

The client module 151 may receive a result corresponding to the received voice input. For example, when the intelligent server 200 is capable of calculating a result corresponding to the received voice input, the client module 151 may receive the result corresponding to the received voice input. The client module 151 may display the received result on the display module 160.

The client module 151 may receive a plan corresponding to the received voice input. The client module 151 may display results of executing a plurality of actions of an app according to the plan on the display module 160. For example, the client module 151 may sequentially display the results of executing the plurality of actions on the display module 160. As another example, the user terminal 101 may display only a portion of the results of executing the plurality of actions (e.g., a result of the last action) on the display module 160.

According to an embodiment, the client module 151 may receive a request for obtaining information necessary for calculating a result corresponding to the voice input from the intelligent server 200. According to an embodiment, the client module 151 may transmit the necessary information to the intelligent server 200 in response to the request.

The client module 151 may transmit information on the results of executing the plurality of actions according to the plan to the intelligent server 200. The intelligent server 200 may confirm that the received voice input has been correctly processed using the information on the results.

The client module 151 may include a speech recognition module. According to an embodiment, the client module 151 may recognize a voice input for performing a limited function through the speech recognition module. For example, the client module 151 may execute an intelligent app for processing a voice input to perform an organic operation through a designated input (e.g., Wake up!).

The intelligent server 200 may receive information related to a user voice input from the user terminal 101 through a communication network. According to an embodiment, the intelligent server 200 may change data related to the received voice input into text data. According to an embodiment, the intelligent server 200 may generate a plan for performing a task corresponding to the user voice input based on the text data.

According to an embodiment, the plan may be generated by an artificial intelligence (AI) system. The artificial intelligence system may be a rule-based system or a neual network-based system (e.g., a feedforward neural network (FNN) or a recurrent neural network (RNN)). Alternatively, the artificial intelligence system may be a combination thereof or other artificial intelligence systems. According to an embodiment, the plan may be selected from a set of predefined plans or may be generated in real time in response to a user request. For example, the artificial intelligence system may select at least one plan from among the predefined plans.

The intelligent server 200 may transmit a result according to the generated plan to the user terminal 101 or transmit the generated plan to the user terminal 101. According to an embodiment, the user terminal 101 may display the result according to the plan on the display module 160. According to an embodiment, the user terminal 101 may display a result of executing an action according to the plan on the display module 160.

The intelligent server 200 may include a front end 210, a atural language platform 220, a capsule database (DB) 230, an execution engine 240, an end user interface 250, a management platform 260, a big data platform 270, or an analytic platform 280.

The front end 210 may receive the received voice input from the user terminal 101. The front end 210 may transmit a response corresponding to the voice input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the user terminal 101 into text data. The NLU module 223 may discern an intent of a user using the text data of the voice input. For example, the NLU module 223 may discern the intent of the user by performing syntactic analysis or semantic analysis. The NLU module 223 may discern the meaning of a word extracted from the voice input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine a relationship between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an embodiment, some or all of the functions of the natural language platform 220 may be implemented in the user terminal 101 as well.

The capsule DB 230 may store information on the relationship between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the voice input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the user terminal 101. According to an embodiment, the capsule DB 230 may include a vocabulary registry that stores vocabulary information included in capsule information. According to an embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an embodiment, the capsule DB 230 may be implemented in the user terminal 101 as well.

The execution engine 240 may calculate a result using the generated plan. The end user interface 250 may transmit the calculated result to the user terminal 101. Accordingly, the user terminal 101 may receive the result and provide the received result to the user. The management platform 260 may manage information used by the intelligent server 200. The big data platform 270 may collect data of the user. The analytic platform 280 may manage a quality of service (QOS) of the intelligent server 200. For example, the analytic platform 280 may manage the components and processing rate (or efficiency) of the intelligent server 200.

The service server 300 may provide a designated service (e.g., food order or hotel reservation) to the user terminal 101. According to an embodiment, the service server 300 may be a server operated by a third party. The service server 300 may provide information to be used for generating a plan corresponding to the received voice input to the intelligent server 200. The provided information may be stored in the capsule DB 230. In addition, the service server 300 may provide result information according to the plan to the intelligent server 200.

In the integrated intelligence system described above, the user terminal 101 may provide various intelligent services to the user in response to a user input. The user input may include, for example, an input through a physical button, a touch input, or a voice input.

In an embodiment, the user terminal 101 may provide a speech recognition service through an intelligent app (or a speech recognition app) stored therein. In this case, for example, the user terminal 101 may recognize a user utterance or a voice input received through the microphone, and provide a service corresponding to the recognized voice input to the user.

In an embodiment, the user terminal 101 may perform a designated action alone or together with the intelligent server and/or a service server, based on the received voice input. For example, the user terminal 101 may execute an app corresponding to the received voice input and perform a designated action through the executed app.

In an embodiment, when the user terminal 101 provides a service together with the intelligent server 200 and/or the service server, the user terminal may detect a user utterance using the input module 150 and generate a signal (or voice data) corresponding to the detected user utterance. The user terminal 101 may transmit the voice data to the intelligent server 200 using the communication module 190.

The intelligent server 200 may generate, as a response to the voice input received from the user terminal 101, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The user terminal 101 may receive the response using the communication module 1907. The user terminal 101 may output a voice signal internally generated by the user terminal 101 to the outside using the sound output module 155, or output an image internally generated by the user terminal 101 to the outside using the display module 160.

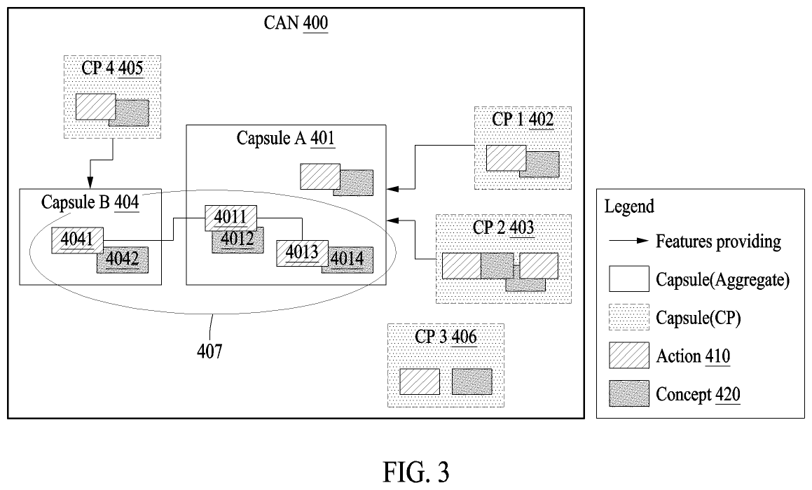

FIG. 3 is a diagram illustrating a form in which relationship information between concepts and actions is stored in a database according to various embodiments.

A capsule DB (e.g., the capsule DB 230) of the intelligent server 200 may store capsules in the form of a concept action network (CAN). The capsule DB may store an action for processing a task corresponding to a voice input of a user and a parameter required for the action in the form of a CAN.

The capsule DB may store a plurality of capsules (a capsule A 401 and a capsule B 404) respectively corresponding to a plurality of domains (e.g., applications). According to an embodiment, one capsule (e.g., the capsule A 401) may correspond to one domain (e.g., a location (geo) application). Further, the one capsule may correspond to at least one service provider (e.g., CP 1 402 or CP 2 403) for performing a function for a domain related to the capsule. According to an embodiment, one capsule may include at least one action 410 for performing a designated function and at least one concept 420.

The natural language platform 220 may generate a plan for performing a task corresponding to the received voice input using the capsules stored in the capsule DB. For example, the planner module 225 of the natural language platform may generate the plan using the capsules stored in the capsule DB. For example, a plan 407 may be generated using actions 4011 and 4013 and concepts 4012 and 4014 of the capsule A 410 and an action 4041 and a concept 4042 of the capsule B 404.

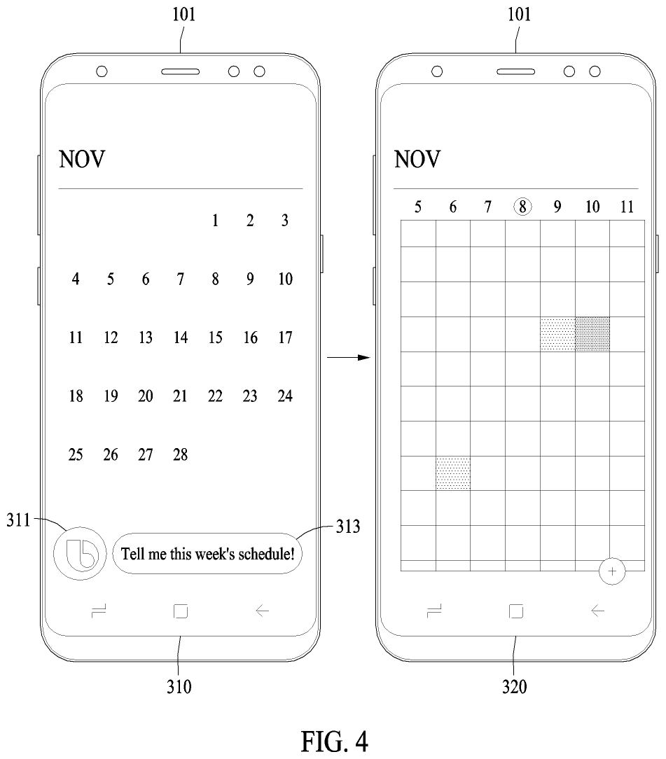

FIG. 4 is a diagram illustrating a screen of a user terminal processing a received voice input through an intelligent app according to various embodiments.

The user terminal 101 may execute an intelligent app to process a user input through the intelligent server 200.

According to an embodiment, on a screen 310, when a designated voice input (e.g., Wake up!) is recognized or an input through a hardware key (e.g., a dedicated hardware key) is received, the user terminal 101 may execute an intelligent app for processing the voice input. The user terminal 101 may execute the intelligent app, for example, in a state in which a scheduling app is executed. According to an embodiment, the user terminal 101 may display an object (e.g., an icon) 311 corresponding to the intelligent app on the display module 160. According to an embodiment, the user terminal 101 may receive a voice input by a user utterance. For example, the user terminal 101 may receive a voice input of “Tell me this week's schedule!”. According to an embodiment, the user terminal 101 may display a user interface (UI) 313 (e.g., an input window) of the intelligent app in which text data of the received voice input is displayed on the display module 160.

According to an embodiment, on a screen 320, the user terminal 101 may display a result corresponding to the received voice input on the display module 160. For example, the user terminal 101 may receive a plan corresponding to the received user input, and display “this week's schedule” on the display module 160 according to the plan.

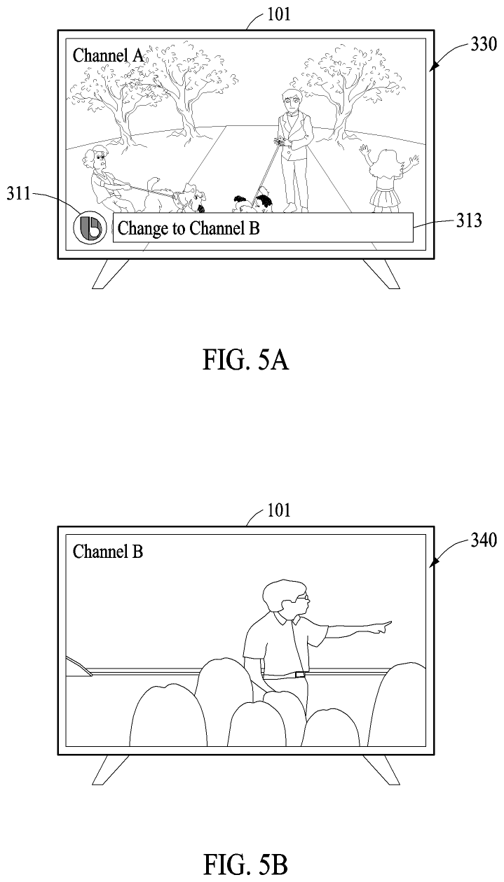

FIGS. 5A and 5B are diagrams illustrating a screen of the electronic device 101 processing a received voice input through an intelligent app according to various embodiments. In FIGS. 5A and 5B, the electronic device 101 may be a device such as a TV, but is not limited thereto.

The electronic device 101 may execute an intelligent app to process a user input through the intelligent server 200.

According to an embodiment, on a screen 330 of FIG. 5A, when a designated voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, in a state in which an app to change the channel of the electronic device 101 is executed. According to an embodiment, the electronic device 101 may display an object (e.g., an icon) 311 corresponding to the intelligent app on the display module 160. According to an embodiment, the electronic device 101 may receive a voice input by a user utterance. For example, the electronic device 101 may receive a voice input of “Change to Channel B”. According to an embodiment, the electronic device 101 may display a user interface (UI) 313 (e.g., an input window) of the intelligent app in which text data of the received voice input is displayed on the display module 160.

According to an embodiment, on a screen 340 of FIG. 5B, the electronic device 101 may display a result corresponding to the received voice input on the display module 160. For example, the electronic device 101 may receive a plan corresponding to the received user input, and display Channel B on the display module 160 according to the plan.

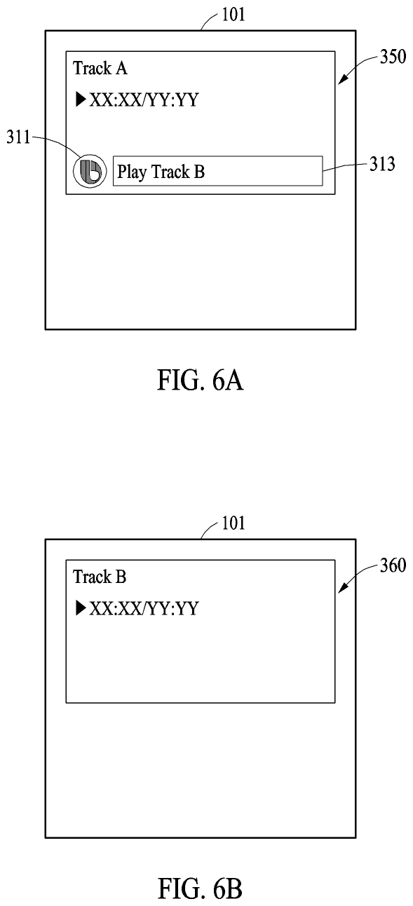

FIGS. 6A and 6B are diagrams illustrating a screen of an electronic device processing a received voice input through an intelligent app according to various embodiments. In FIGS. 6A and 6B, the electronic device 101 may be a device, for example, an artificial intelligence (AI) speaker, including a display module (e.g., the display module 160 of FIG. 1) and/or a sound output module (e.g., the sound output module 155 of FIG. 1) to output a sound signal to the outside, but is not limited thereto.

FIG. 6A is a diagram illustrating a screen of the electronic device 101 processing a received voice input through an intelligent app according to various embodiments.

The electronic device 101 may execute an intelligent app to process a user input through the intelligent server 200.

According to an embodiment, on a screen 350 of FIG. 6A, when a designated voice input (e.g., Wake up!) is recognized or an input through a hardware key (e.g., a dedicated hardware key) is received, the electronic device 101 may execute an intelligent app for processing the voice input. For example, the electronic device 101 may execute an intelligent app while executing an app to change audio data played by the electronic device 101. According to an embodiment, the electronic device 101 may display an object (e.g., an icon) 311 corresponding to the intelligent app on the display module 160. According to an embodiment, the electronic device 101 may receive a voice input by a user utterance. For example, the electronic device 101 may receive a voice input of “Play Track B”. According to an embodiment, the electronic device 101 may display a user interface (UI) 313 (e.g., an input window) of the intelligent app in which text data of the received voice input is displayed on the display module 160.

According to an embodiment, on a screen 360 of FIG. 6B, the electronic device 101 may display a result corresponding to the received voice input on the display module 160. For example, the electronic device 101 may receive a plan corresponding to the received user input, play Track B according to the plan, and display information about Track B being played on the display module 160.

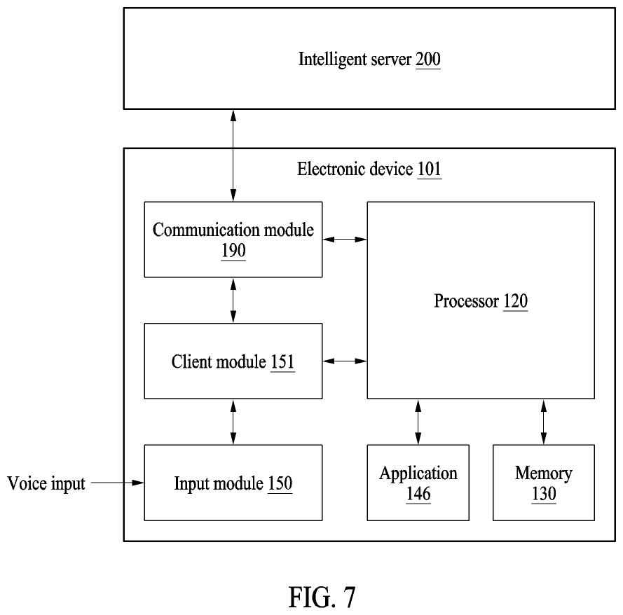

FIG. 7 is a diagram illustrating an operation of determining a recommended command using a voice input by the electronic device 101 according to an embodiment.

The electronic device 101 according to various embodiments may receive a voice input through the input module 150. As an example, the input module 150 of the electronic device 101 may include a voice input device such as a microphone, and receive a voice input by detecting an utterance of a user input through the voice input device. As an example, the voice input device of the electronic device 101 may digitize an analog voice signal and transmit the digitized voice signal to the processor 120 of the electronic device 101.

As a different example from the embodiment shown in FIG. 7, the electronic device 101 may receive a voice input of a user collected by an external electronic device (e.g., the electronic device 102 of FIG. 2). As an example, the electronic device 101 may directly or wirelessly receive the voice input collected by the external electronic device 102 through an audio interface supported by the interface 177. For example, if the electronic device 101 is a TV, a voice input may be collected through a microphone in a remote controller, and the electronic device 101 may receive the voice input collected by the remote controller through the audio interface supported by the interface 177.

As an example, the external electronic device 102 may digitize an analog voice signal, and the electronic device 101 may receive the digitized voice signal from the external electronic device 102 through a network (e.g., the first network 198 or the second network 199 of FIG. 1).

The client module 151 according to various embodiments may identify a designated voice input, for example, a wake-up word, from the voice input. As an example, the wake-up word may be a command to start an action related to speech recognition using the voice input received from the user. As an example, the client module 151 may identify the wake-up word in the voice input and perform speech recognition using a voice input following the wake-up word.

As an example, the client module 151 may include a speech recognition module, and the client module 151 may perform an operation for processing a voice input when identifying a designated input (e.g., Wake up!), such as a wake-up word, through the speech recognition module. As an example, the client module 151 may transmit the received voice input to the intelligent server 200 to process the voice input.

The electronic device 101 according to various embodiments may transmit the voice input to the intelligent server 200 through the communication module 190. As an example, when the wake-up word is identified by the client module 151, the electronic device 101 may transmit the voice input to the intelligent server 200.

According to an embodiment, the intelligent server 200 may generate a plan (e.g., the plan 407 of FIG. 3) corresponding to the voice input using the voice input received from the electronic device 101, or calculate the result of processing the plan corresponding to the voice input. As an example, the voice input of the user may include a wake-up word and a command following the wake-up word. For example, the voice input including the wake-up word and the command may be transmitted to the intelligent server 200, or the voice input including the command following the wake-up word may be transmitted to the intelligent server 200.

As an example, the intelligent server 200 may generate a plan according to the command included in the voice input. As an example, the intelligent server 200 may include a natural language platform (e.g., the natural language platform 220 of FIG. 2). As an example, an ASR module (e.g., the ASR module 221 of FIG. 2) of the natural language platform may convert the voice input into text, and an NLU module (e.g., the NLU module 223 of FIG. 2) may discern an intent of the user using the text data of the voice input. As an example, a planner module (e.g., the planner module 225 of FIG. 2) of the natural language platform may generate the plan using the determined intent and parameters.

As an example, the planner module may determine a plurality of domains required to perform a task based on the determined intent. The planner module may determine a plurality of actions included in each of the plurality of domains determined based on the intent. As an example, the plan generated by the planner module may include a plurality of actions and a plurality of concepts, in the plurality of domains determined according to the determined intent.

According to an embodiment, the intelligent server 200 may transmit the generated plan or the result of processing the plan to the communication module 190 of the electronic device 101 in response to the voice input. As an example, the intelligent server 200 may transmit the plan generated by processing the voice input to the electronic device 101. As an example, the intelligent server 200 may transmit the result of execution according to the plan generated by processing the voice input to the electronic device 101.

In an embodiment different from the embodiment shown in FIG. 7, the electronic device 101 may generate a plan based on a voice input. For example, the electronic device 101 may include a natural language platform for processing the voice input. When the client module 151 identifies a wake-up word from the received voice input, the client module 151 may transmit the voice input to the natural language platform included in the electronic device 101. The natural language platform of the electronic device 101 may operate in substantially the same manner as the natural language platform of the intelligent server 200, which converts a voice input into text and generates a plan by discerning an intent of the user.

As an example, the electronic device 101 may include at least one, or a combination, of an ASR module (e.g., the ASR module 221 of FIG. 2), an NLU module (e.g., the NLU module 223 of FIG. 2), a planner module (e.g., the planner module 225 in FIG. 2), an NLG module (e.g., the NLG module 227 of FIG. 2), and a TTS module (e.g., the TTS module 229 of FIG. 2) of the natural language platform. For example, the electronic device 101 may include the ASR module to convert a voice input into text. The electronic device 101 may transmit the converted text data to the intelligent server 200 and receive a response to the transmitted text data from the intelligent server 200.

As an example, the electronic device 101 may include at least one of a capsule DB (e.g., the capsule DB 230 of FIG. 2), an execution engine (e.g., the execution engine 240 of FIG. 2), an end user interface (e.g., the end user interface 250 of FIG. 2), a management platform (e.g., the management platform 260 of FIG. 2), a big data platform (e.g., the big data platform 270 of FIG. 2), or an analytic platform (e.g., the analytic platform 270 of FIG. 2).

As an example, the electronic device 101 may transmit the received voice input to the intelligent server 200. The intelligent server 200 may change the received voice input into text data and transmit the text data to the electronic device 101. For example, the intelligent server 200 that converts the received voice input into text data and transmits the text data to the electronic device 101 may be referred to as a speech-to-text (STT) server.

As an example, the electronic device 101 may include at least one of the NLU module (e.g., the NLU module 223 of FIG. 2), the planner module (e.g., the planner module 225 in FIG. 2), the NLG module (e.g., the NLG module 227 of FIG. 2), and the TTS module (e.g., the TTS module 229 of FIG. 2) of the natural language platform. As an example, the electronic device 101 may generate plans using the text data received from the intelligent server 200.

The processor 120 of the electronic device 101 according to various embodiments may execute the client module 151 according to the plans received from the intelligent server 200. For example, the processor 120 may execute at least one of the client module 151 or an SDK (e.g., the SDK 153 of FIG. 2) to run at least one of the plurality of apps 146.

The electronic device 101 according to various embodiments may determine whether domains of a plurality of plans consecutively generated are identical by a preset number or more. As an example, the domains may correspond to capsules (e.g., the capsules 401, 402, 403, 404, 405, and 406 of FIG. 3) including actions (e.g., the actions 410 of FIG. 3) and concepts (e.g., the concepts 420 of FIG. 3) according to the plans. As an example, the domains may correspond to the applications 146. For example, if the electronic device 101 is a TV, it may be determined whether the domains of the plurality of plans consecutively generated are identical by the set number or more, as applications 146 for channel change.

As an example, the electronic device 101 may determine whether at least one of the intents, parameters, actions, or concepts of the plurality of plans are identical by a preset number or more. For example, if the electronic device 101 is a TV, it may be determined whether the actions and/or concepts of the plurality of plans are identical by the set number or more, as an action and/or concept for channel change. As an example, the electronic device 101 may receive data about the intents, parameters, actions, or concepts of the plurality of plans from the intelligent server 200, or identify the data from the natural language platform of the electronic device 101.

As an example, the electronic device 101 may determine whether the domains of the plurality of plans are identical by a preset number or more. For example, it may be determined whether the domains of ten plans are identical by five or more.

The electronic device 101 according to various embodiments may obtain recommended commands based on the domains when the domains of the plurality of plans are identical by the preset number or more. As an example, the obtained recommended commands may be identified by the client module 151 in substantially the same manner as the wake-up word. For example, when identifying a recommended command included in the voice input, the client module 151 may perform an operation for speech recognition. As an example, the recommended commands may be obtained corresponding to the plans. The electronic device 101 may store the obtained recommended commands in the memory 130.

As an example, the electronic device 101 may obtain the recommended commands based on the domains. For example, if the electronic device 101 is a TV, and the domains of the plurality of plans are identical, as the applications 146 to change the channel, the electronic device 101 may obtain channels to change to as recommended commands based on the domains.

For example, if the electronic device 101 is a TV, and the domains the plurality of plans are identical by a preset number or more, as the applications 146 to change the channel, the electronic device 101 may obtain recommended commands based on the domains. For example, the electronic device 101 may obtain recommended commands, such as “Channel A”, “Channel B”, and “Channel A”, which are names of channels to change to in the applications 146 for channel change, based on the domains, for example, the applications 146 for channel change.

As an example, the electronic device 101 may obtain recommended commands based on data received from the plurality of applications 146. For example, when the domains of the plurality of plans are identical, as an application A for channel change, the electronic device 101 may receive a list of channels to change to from the application A and obtain recommended commands using the received list of channels.

As an example, when the actions and/or concepts of the plurality of plans are identical, the electronic device 101 may obtain recommended commands based on the action and/or concept. For example, if the electronic device 101 is a TV, and the actions of the plurality of plans are identical, as an action to change the channel, the electronic device 101 may obtain channels to change to as recommended commands based on the action.

As an example, the electronic device 101 may obtain recommended commands based on a common action of the plurality of plans. For example, if Plan 1 includes Action A, Action B, and Action C, Plan 2 includes Action D, Action E, and Action C, and Plan 3 includes Action F, Action G, and Action C, then the electronic device 101 may obtain recommended commands based on Action C, which is common to the plurality of plans.

As an example, when the concepts of the plurality of plans are identical, the electronic device 101 may obtain recommended commands based on the concepts. As an example, the concept may be obtained by defining parameters input to the execution of an action or a result value output by the execution of an action. When the concepts of the plurality of plans are identical, for example, when the parameters input and/or output to execute actions included in the plurality of plans are identical, the electronic device 101 may obtain recommended commands based on the concepts.

For example, if the electronic device 101 is a TV, and the concepts of the plurality of plans, for example, the parameters input are identical, as channels to change to, the electronic device 101 may obtain the channels to change to as the recommended commands.

As an example, the electronic device 101 may obtain recommended commands based on an intent of the user and/or parameters determined based on the voice input. For example, if the electronic device 101 is a TV, the intent of the user is to change the channel of the electronic device 101, and the parameters are identical as channels to change to, the electronic device 101 may obtain the channels to change to as the recommended commands.

As an example, the electronic device 101 may obtain recommended commands using data received from the intelligent server 200 and/or information about the user stored in the memory 130. As an example, the electronic device 101 may transmit and receive the data with the intelligent server 200 using the communication module 190. As an example, the electronic device 101 may receive the data stored in the big data platform of the intelligent server 200 and obtain recommended commands using the received data. For example, when the domains of the plurality of plans are identical, as the applications 146 for channel change, the electronic device 101 may obtain recommended commands using data of the user stored in the big data platform, for example, data about viewer ratings for channels at the same time.

As an example, the electronic device 101 may obtain recommended commands using the information about the user. As an example, the memory 130 of the electronic device 101 may store the information about the user. For example, the information about the user stored in the memory 130 may include information such as viewing time for each channel, favorite channels, and the age and gender of the user. For example, the electronic device 101 may use the information about the user to obtain channels that the user mostly watches as the recommended commands.

As an example, the electronic device 101 may obtain recommended commands using data received from the intelligent server 200 and information about the user stored in the memory 130. As an example, the data received from the intelligent server 200 may include data stored in the big data platform of the intelligent server 200. For example, the recommended commands may be obtained based on the age group of the user, which is the information about the user stored in the memory 130, and the viewer ratings for age groups received from the intelligent server 200.

As an example, the electronic device 101 may obtain recommended commands related to channels expected to be highly preferred by the user using the information about the user stored in the memory 130 and/or the data received from the intelligent server 200.

The above examples are examples of recommended commands obtained by the electronic device 101 based on the domains, intents, parameters, actions, concepts, the information about the user, and the data received from the intelligent server 200 when the domains of the plurality of plans are identical by a preset number or more. According to an embodiment, the intelligent server 200 may obtain the recommended commands based on the domains, intents, parameters, actions, concepts, the information about the user, and the data stored in the intelligent server 200. The intelligent server 200 may transmit data including the obtained recommended commands to the electronic device 101. The electronic device 101 may obtain the recommended commands using the received data. As an example, the intelligent server 200 may obtain the recommended commands from the NLG module.

As an example, the electronic device 101 may provide the generated recommended commands to the user. As an example, the electronic device 101 may output the recommended commands to the display module 160. As an example, the electronic device 101 may output the recommended commands to a display module of an external electronic device through an interface. As an example, the electronic device 101 may output the recommended commands through the sound output module 155. As an example, the recommended commands may be converted into a voice signal by the TTS module of the intelligent server 200 or the TTS module of the natural language platform included in the electronic device 101.

As an example, the interface 177 of the electronic device 101 may support one or more designated protocols for direct or wireless connection with the external electronic device. For example, the electronic device 101 may be coupled to the external electronic device by wire through a connecting terminal (e.g., the connecting terminal 178 of FIG. 1), or may be coupled to the external electronic device (e.g., the electronic device 102 or 104 of FIG. 1) wirelessly through a first network (e.g., the first network 198 of FIG. 1) or a second network (e.g., the second network 199 of FIG. 1).

As an example, the electronic device 101 may transmit an image signal to the external electronic device through the connecting terminal. The electronic device may transmit an image signal that allows the external electronic device to output an image to the display module of the external electronic device.

As an example, the electronic device 101 may include a connecting terminal for outputting an image signal and/or a connecting terminal for outputting a voice signal. As an example, the electronic device 101 may include a connecting terminal for simultaneously outputting an image signal and a voice signal. For example, the electronic device may output an image signal and a voice signal to the external electronic device through an interface, such as high definition multimedia interface (HDMI), DisplayPort (DP), or Thunderbolt, from the connecting terminal for simultaneously outputting an image signal and a voice signal. As an example, the electronic device 101 may transmit a signal to output an image signal and/or a voice signal to a second external electronic device to the external electronic device. For example, the second external electronic device may be coupled to the external electronic device, and the external electronic device may output an image signal and/or a voice signal to the second external electronic device. The electronic device may transmit the signal to output an image signal and/or a voice signal to the second external electronic device, causing the external electronic device to output an image signal and/or a voice signal to the second external electronic device.

The electronic device 101 according to various embodiments may store the obtained recommended commands in the memory 130. As an example, the electronic device 101 may match the recommended commands to recommended wake-up words, and store the matching relationship between the recommended wake-up words and the recommended commands in the memory 130.

As an example, the electronic device 101 may identify at least one of a wake-up word, a recommended wake-up word, and a recommended command stored in the memory 130. When identifying at least one of a wake-up word, a recommended wake-up word, and a recommended command, the electronic device 101 may perform an operation for processing a voice input or an operation for speech recognition. The operation for processing a voice input or the operation for speech recognition may refer to operations for generating a plan by processing the voice input, such as, for example, an operation of transmitting the voice input to the intelligent server 200, or an operation of receiving a plan or the result of executing the plan in response to the voice input from the intelligent server 200.

As an example, the electronic device 101 may identify a recommended command from the voice input. As an example, the client module 151 of the electronic device 101 may identify a wake-up word or recommended command using the voice input, and perform an operation for speech recognition when the wake-up word or recommended command is identified. As an example, the electronic device 101 may identify a recommended command using the voice input, perform an operation for speech recognition, and generate a plan using the recommended command.

For example, when the client module 151 identifies a recommended command “Channel A” from the received voice input, the electronic device 101 may transmit the voice input to the intelligent server 200 using the communication module 190.

For example, when the client module 151 identifies the recommended command “Channel A” from the received voice input, the electronic device 101 may input the voice input into the natural language platform.

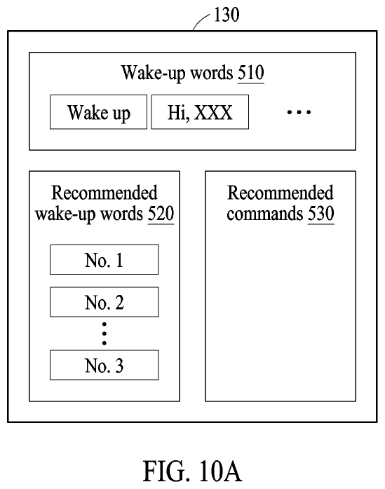

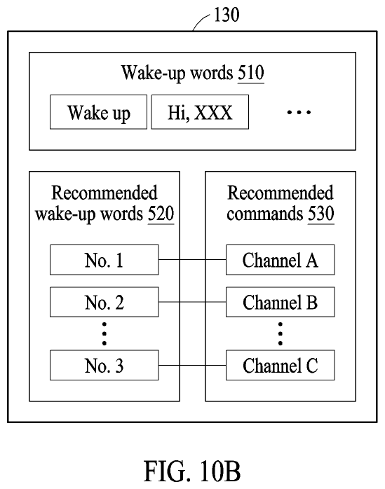

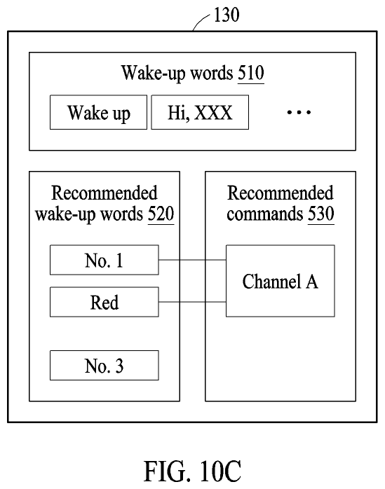

As an example, the electronic device 101 may identify a recommended wake-up word corresponding to the recommended command. The recommended wake-up word corresponding to the recommended command will be described with reference to FIG. 10.

The client module 151 of the electronic device 101 according to various embodiments may identify a voice input including a recommended command. As an example, the client module 151 may identify a recommended command in substantially the same manner as identifying a wake-up word included in the voice input. For example, the speech recognition module of the client module 151 may identify a recommended command. The electronic device 101 according to various embodiments may execute the client module 151 according to a plan generated based on the recommended command.

The electronic device 101 according to various embodiments may determine whether a voice input including a recommended wake-up word or recommended command is received from the user within a preset time. If a voice input including a recommended wake-up word or recommended command is not received within the preset time, the electronic device 101 may delete the recommended command stored in the memory 130.

As an example, the electronic device 101 may generate a plan using the recommended command. As an example, the electronic device 101 may transmit a voice input including the recommended command to the intelligent server 200 to generate a plan according to the recommended command, or to cause the natural language platform of the electronic device 101 to generate a plan according to the recommended command.

In the above example, recommended commands may correspond to plans. For example, a recommended command “Channel A” may correspond to a plan to change the channel of the electronic device 101 to Channel A. For example, the recommended command “Channel A” may correspond to at least one of the domain, intent, parameter, action, and concept of the plan to change the channel of the electronic device 101 to Channel A.

As an example, the intelligent server 200 may match a recommended command to a plan. For example, when the domains of a plurality of plans are identical, the intelligent server 200 may generate recommended commands based on the plurality of plans. As an example, the intelligent server 200 may transmit data including the generated recommended commands to the electronic device 101, and the electronic device 101 may determine a recommended command using the received data.

As an example, the intelligent server 200 may match respective plans to the generated recommended commands. For example, if the domains of the plurality of plans are identical, as the applications 146 for channel change, and the recommended commands generated by the intelligent server 200 are “Channel A”, “Channel B”, and “Channel C”, the intelligent server 200 may match the generated recommended commands to a plan to change the channel of the electronic device 101 to Channel A, a plan to change the channel of the electronic device 101 to Channel B, and a plan to change the channel of the electronic device 101 to Channel C, respectively.

As an example, the intelligent server 200 may receive a voice input including a recommended command corresponding to a plan from the electronic device 101, generate a plan corresponding to the recommended command using the voice input, and transmit the plan to the electronic device 101. In the above example, when the intelligent server 200 receives a voice input corresponding to a recommended command “Channel A” from the electronic device 101, the intelligent server 200 may generate a plan to change the channel of the electronic device 101 to Channel A and transmit the plan to the electronic device 101.

As an example different from the above example in which the intelligent server 200 matches a recommended command to a plan, the electronic device 101 may match a recommended command to a plan. As an example, the electronic device 101 may match a recommended command to an intent and/or parameters required to generate a plan.

As an example, when identifying a recommended command included in the voice input of the user, the electronic device 101 may generate an intent and/or parameters to generate a plan using the recommended command. As an example, the electronic device 101 may transmit the generated intent and/or parameters to the natural language platform included in the intelligent server 200 or the electronic device 101. As an example, the natural language platform included in the intelligent server 200 or the electronic device 101 may generate a plan corresponding to the recommended command using the intent and/or parameters.

For example, if the domains of the plurality of plans are identical, as the applications 146 for channel change, and the recommended commands generated by the electronic device 101 are “Channel A”, “Channel B”, and “Channel C”, the electronic device 101 may match the generated recommended commands to an intent and/or parameters necessary for the plan to change the channel of the electronic device 101 to Channel A, an intent and/or parameters necessary for the plan to change the channel of the electronic device 101 to Channel B, and an intent and/or parameters necessary for the plan to change the channel of the electronic device 101 to Channel C, respectively.

As an example, to generate the intent and/or parameters corresponding to the recommended command, the electronic device 101 may transmit the data necessary to match the recommended command to the intent and/or parameters required for the plan to the intelligent server 200, or receive the data from the intelligent server 200. For example, the electronic device 101 may receive the intent and/or parameters to generate the plan corresponding to the recommended command “Channel A” from the intelligent server 200, and match the received intent and/or parameters to the recommended command “Channel A”.

As an example, the intelligent server 200 may receive the intent and/or parameters necessary to generate the plan corresponding to the recommended command from the electronic device 101, and generate the plan corresponding to the recommended command. As an example, in the natural language platform of the intelligent server 200, the planner module may generate the plan corresponding to the recommended command using the intent and/or parameters.

As an example, the electronic device 101 may input the intent and/or parameters necessary to generate the plan corresponding to the recommended command into the natural language platform of the electronic device 101. In the natural language platform of the electronic device 101, the planner module may generate the plan corresponding to the recommended command using the intent and/or parameters.

As an example, the electronic device 101 may generate at least one of the intent, parameters, action, and concept necessary to generate the plan corresponding to the recommended command using the recommended command, and transmit at least one of the intent, parameters, action, and concept to the intelligent server 200 or input the same into the natural language platform of the electronic device 101 to generate the plan corresponding to the recommended command.

In the above description, when the domains of the plurality of plans generated according to the voice input of the user are identical by a set number or more, the electronic device 101 may generate recommended commands reflecting the intent of the user. The electronic device 101 may identify the recommended command included in the voice input, and operate according to the plan generated based on the recommended command. The electronic device 101 may identify the recommended command and perform an operation for speech recognition, thereby improving the user convenience by performing the operation for speech recognition even when the user does not utter a wake-up word. The electronic device 101 may determine a recommended command and provide the recommended command to the user, thereby improving the user convenience.

For example, when the natural language platform of the intelligent server 200 or the electronic device 101 generates the plan based on the recommended command, the natural language platform may generate the plan based on the recommended command without processing the voice input using the ASR module and/or the NLU module.

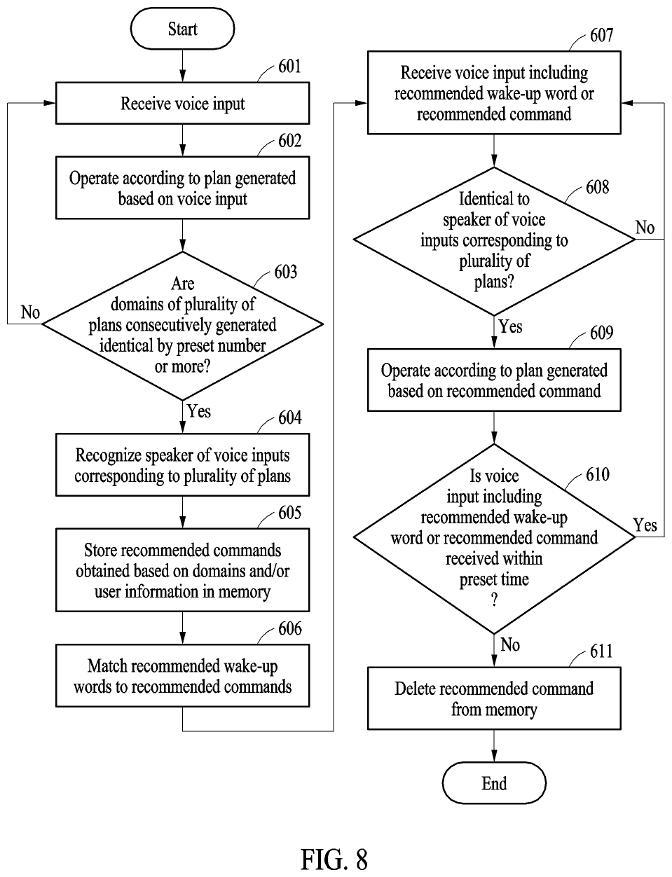

FIG. 8 is a diagram illustrating an operation of obtaining a recommended command and recognizing the recommended command by an electronic device (e.g., the electronic device 101 of FIG. 1) according to an embodiment.

An electronic device according to various embodiments may receive a voice input, in operation 601. For example, the electronic device may receive a voice input of the user through an input module (e.g., the input module 150 of FIG. 1), or receive a voice input of the user collected by an external electronic device (e.g., the electronic device 102 of FIG. 1), for example, a controller, through an interface (e.g., the interface 177 of FIG. 1).

As another example, a voice input of the user may be collected by a microphone provided in the external electronic device such as a smart phone, and the electronic device may receive the voice input collected by the external electronic device through the interface 177 or a network (e.g., the first network 198 or the second network 199 of FIG. 1). As an example, the smart phone and the external electronic device may include an application for collecting a voice input and transmitting the voice input to the electronic device 101.

The electronic device according to various embodiments may operate according to a plan (e.g., the plan 407 of FIG. 3) generated based on the voice input, in operation 602. As an example, the electronic device may identify a wake-up word included in the voice input and perform an operation for speech recognition. As an example, when the electronic device identifies the wake-up word, the electronic device may transmit the voice input to an intelligent server (e.g., the intelligent server 200 of FIG. 2), receive a plan in response to the voice input, and operate according to the plan. As an example, the electronic device may generate the plan by inputting the voice input into a natural language platform (e.g., the natural language platform 220 of FIG. 2) of the electronic device, and operate according to the plan.

The electronic device according to various embodiments may determine whether domains of a plurality of plans consecutively generated are identical by a preset number or more, in operation 603. As an example, the electronic device may determine whether at least one of the intents, parameters, actions (e.g., the action 410 of FIG. 3), and concepts (e.g., the concept 420 of FIG. 3) of the plurality of plans are identical.

When the domains of the plurality of plans are identical by a preset number or more in operation 603, the electronic device according to various embodiments may recognize a speaker corresponding to the plurality of plans, in operation 604. As an example, the electronic device may recognize the speaker using the voice input and information such as tone, pronunciation, gender, and pitch. To recognize the speaker corresponding to the plurality of plans, known techniques may be applied.

The electronic device according to various embodiments may obtain recommended commands based on the domains and/or user information and store the obtained recommended commands in a memory (e.g., the memory 130 of FIG. 1), in operation 605. As an example, the electronic device may obtain the recommended commands based on the domains of the plurality of plans and the user information. For example, if the user information includes channels preferred by the user on a predetermined day and/or a time window, the electronic device may obtain recommended commands including the channels.

As an example, the electronic device may obtain the recommended commands based on at least one of the domains, intents, parameters, actions, and concepts of the plurality of plans.

The electronic device according to various embodiments may match recommended wake-up words to the recommended commands, in operation 606. As an example, the memory may store the recommended wake-up words. As an example, the client module of the electronic device may identify at least one of a wake-up word, a recommended wake-up word, and a recommended command. As an example, the electronic device may determine whether a recommended wake-up word corresponds to a recommended command, and the client module of the electronic device may identify a recommended wake-up word corresponding to a recommended command.

For example, the client module of the electronic device may perform an operation for speech recognition when identifying a recommended wake-up word corresponding to a recommended command, and may not start the operation for speech recognition when identifying a recommended wake-up word not corresponding to a recommended command.

The electronic device according to various embodiments may receive a voice input including a recommended wake-up word or recommended command, in operation 607.

The electronic device according to various embodiments may determine whether the speaker of the voice input including the recommended wake-up word or recommended command is identical to the speaker of voice inputs corresponding to the plurality of plans, in operation 608. The electronic device may identify the recommended wake-up word or recommended command in operation 608, and in operation 608, the electronic device may operate in substantially the same manner as in operation 602 of identifying a wake-up word. As an example, the electronic device may determine whether the speakers are identical, in substantially the same manner as in operation 604 of recognizing a speaker.

When it is determined in operation 608 that the speaker of the voice input including the recommended wake-up word or recommended command is identical to the speaker of voice inputs corresponding to the plurality of plans, the electronic device according to various embodiments may operate according to a plan generated based on the recommended command, in operation 609. As an example, the electronic device may execute a client module (e.g., the client module 151 of FIG. 2) and/or an SDK (e.g., the SDK 153 of FIG. 2) according to the plan generated based on the recommended command, and run a plurality of apps (e.g., the first app 146-1 and the second app 146-2 of FIG. 2).

As an example, a recommended command may correspond to a plan, and the intelligent server or the electronic device may generate a plan corresponding to a recommended command using the recommended command. For example, the intelligent server may receive a voice input including a recommended command from the electronic device and transmit a plan generated based on the recommended command to the electronic device. For example, the intelligent server may receive data necessary for generating a plan corresponding to the recommended command, for example, data related to at least one of the intent, parameters, action, and concept to generate a plan corresponding to the recommended command, and transmit a plan generated using the received data to the electronic device. For example, the electronic device may generate the plan corresponding to the recommended command in a natural language platform of the electronic device using the recommended command.

When the speaker of the voice inputs corresponding to the plurality of plans is not identical to the speaker of the voice input including the recommended wake-up word or recommended command in operation 608 of FIG. 8, the electronic device may perform an operation of receiving a voice input including a recommended wake-up word or recommended command, according to operation 607. For example, when the speakers of the voice inputs are not identical, the electronic device may not generate a plan using the received voice input, and receive a new voice input including a recommended wake-up word or recommended command according to operation 607.

Operation 608 shown in FIG. 8 corresponds to an embodiment among various embodiments, and the electronic device may operate differently from as in operation 608 shown in FIG. 8. For example, as a different example from the embodiment shown in FIG. 8, when it is identified in operation 608 that the speakers of the voice inputs are not identical, the electronic device may operate according to a plan generated based on the recommended command included in the voice input. The electronic device may obtain a recommended command based on user information of an identified speaker, for example, the speaker uttering the voice input of operation 607, and match a recommended wake-up word to the recommended command. The electronic device may operate according to the recommended command, and output recommended commands and/or recommended commands generated based on the user information of the speaker uttering the voice input of operation 607 to the display module.

The electronic device according to various embodiments may determine whether a voice input including a recommended wake-up word or recommended command is received within a preset time, in operation 610.

If a voice input including a recommended wake-up word or recommended command is not received within the preset time in operation 610, the electronic device according to various embodiments may delete the recommended command stored in the memory, in operation 611.

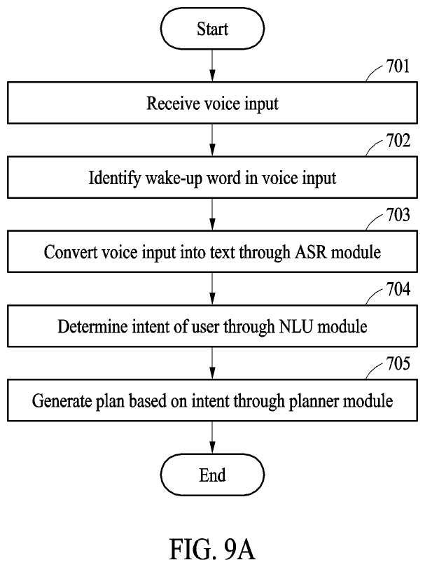

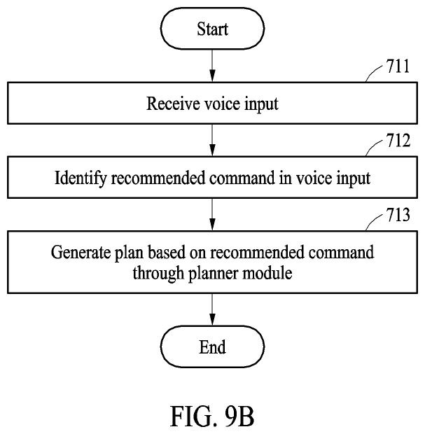

FIGS. 9A and 9B are diagrams illustrating an operation of generating a plan (e.g., the plan 407 of FIG. 3) according to a received voice input by an electronic device (e.g., the electronic device 101 of FIG. 1) according to an embodiment.

FIG. 9A is a diagram illustrating an operation of generating a plan when the electronic device 101 receives a voice input including a wake-up word and a command, and FIG. 9B is a diagram illustrating an operation of generating a plan when the electronic device 101 receives a voice input including a recommended command.

Referring to FIG. 9A, the electronic device 101 according to various embodiments may receive a voice input, in operation 701. As an example, the voice input received by the electronic device 101 in operation 701 may include a wake-up word and a command following the wake-up word. For example, the wake-up word may correspond to an input to start speech recognition by processing the received voice input. As in operations 702 to 705 described later, the electronic device 101 may generate a plan by processing the command following the wake-up word included in the voice input.

For example, if a voice input uttered by a user is “Hi XXX, Channel A”, “Hi XXX” may correspond to a wake-up word, and “Channel A” may correspond to a command.

The electronic device 101 according to various embodiments may identify the wake-up word included in the voice input, in operation 702. As an example, a client module may include a speech recognition module, and the speech recognition module may identify the wake-up word included in the voice input.

The electronic device 101 according to various embodiments may convert the voice input into text through an ASR module (e.g., the ASR module 221 of FIG. 2) of a natural language platform (e.g., the natural language platform 220 of FIG. 2), in operation 703, and determine an intent of the user using the converted text through an NLU module (e.g., the NLU module 223 of FIG. 2) of the natural language platform, in operation 704. The electronic device 101 according to various embodiments may generate a plan based on the intent through a planner module (e.g., the planner module 225 of FIG. 2) of the natural language platform, in operation 705.

Referring to FIG. 9B, the electronic device 101 according to various embodiments may receive a voice input, in operation 711. As an example, the voice input received by the electronic device 101 in operation 711 may include a recommended command. As an example, when domains of a plurality of plans are identical, the electronic device 101 may obtain recommended commands based on the domains and store the obtained recommended commands in a memory (e.g., the memory 130 of FIG. 1).

The electronic device 101 according to various embodiments may identify the recommended command included in the voice input, in operation 712. As an example, a client module (e.g., the client module 151 of FIG. 7) may include a speech recognition module, and the speech recognition module may identify the recommended command included in the voice input.

The electronic device 101 according to various embodiments may generate a plan based on the recommended command through the planner module of the natural language platform, in operation 713. For example, the electronic device 101 may match plans to recommended commands, and the natural language platform may generate a plan corresponding to the input recommended command. Whereas the planner module generates a plan based on the intent determined through the NLU module according to the text converted by the ASR module in operation 705, the planner module may generate a plan corresponding to the recommended command, in operation 713.

Referring to FIGS. 9A and 9B above, the electronic device 101 may identify a recommended command, start an operation for speech recognition, and generate a plan based on the recommended command. The electronic device 101 according to various embodiments may operate upon receiving the voice input including the recommended command, thereby reducing the inconvenience of the user needing to utter a wake-up word and a command.

Referring to FIGS. 9A and 9B above, the electronic device 101 may generate a plan based on the recommended command. According to the embodiment shown in FIG. 9A, the electronic device 101 may convert the voice input into text through the ASR module, and perform an operation of determining the intent of the user through the NLU module. According to the embodiment shown in FIG. 9B, the electronic device 101 may generate a plan according to the recommended command, thereby reducing resources used to process the voice input and perform speech recognition.

In the above example, operations 703, 704, and 705 describe the embodiment in which the electronic device 101 includes the Natural language platform and the ASR module, the NLU module, and the planner module included in the natural language platform of the electronic device generate a plan using a voice input.

In an embodiment different from the embodiment shown in FIGS. 9A and 9B, the electronic device 101 may identify a wake-up word or recommended command and transmit the voice input to an intelligent server (e.g., the intelligent server 200 of FIG. 2), in operation 702 and/or operation 712. As described with reference to FIGS. 7 to 8, the intelligent server may perform substantially the same operations as operations 703, 704, 705, and 713. The electronic device 101 may receive a plan or the result of executing the plan from the intelligent server 200 in response to the voice input.

FIGS. 10A, 10B, and 10C are diagrams illustrating wake-up words 510, recommended wake-up words 520, and recommended commands 530 stored in the memory 130 of an electronic device (e.g., the electronic device 101 of FIG. 1) according to an embodiment.

FIG. 10A is a block diagram illustrating the memory 130 in which the set wake-up words 510 and the recommended wake-up words 520 are stored. Referring to FIG. 10A, the memory 130 of the electronic device may store the set wake-up words 510 and the recommended wake-up words 520.

For example, in FIG. 10A, a client module (e.g., the client module 151 of FIG. 2) of the electronic device may identify a wake-up word 510 included in a voice input using the voice input and a wake-up word 510 stored in the memory 130. When identifying the wake-up word 510, the client module may process the voice input and perform an operation for performing speech recognition. For example, the operation for performing speech recognition may refer to an operation of transmitting a voice input to an intelligent server (e.g., the intelligent server 200 of FIG. 2), running intelligent apps (e.g., the plurality of apps 146 of FIG. 2), or inputting a voice input into a natural language platform (e.g., the natural language platform 220 of FIG. 2) of the electronic device.

As an example, the electronic device may determine whether a recommended wake-up word 520 corresponds to a recommended command 530 and identify the recommended wake-up word 520 corresponding to the recommended command 530. FIG. 10A illustrates wake-up words 510 and recommended wake-up words 520 stored in the memory 130 before recommended commands 530 obtained by the electronic device are stored in the memory 130. In FIG. 10A, when identifying a recommended wake-up word 520 included in the voice input, the client module 151 may not perform an operation for speech recognition, unlike when identifying the wake-up word 510.

As another example, the electronic device 101 may identify a recommended wake-up word 520 corresponding to the recommended command 530. For example, the electronic device 101 may perform speech recognition from the received voice input and determine whether the result of performing speech recognition includes a wake-up word 510 or a recommended wake-up word 520. The electronic device 101 may determine whether the result includes a recommended wake-up word 520, based on the recommended wake-up word 520 corresponding to the recommended command 530, and may not determine whether the result includes a recommended wake-up word 520 not corresponding to the recommended command 530.

For example, in FIG. 10A, the electronic device 101 may not determine whether the speech recognition result includes any one of “No. 1”, “No. 2”, and “No. 3” of the recommended wake-up words 520, and may determine whether the speech recognition result includes any one of “Wake up” and “Hi, XXX” of the wake-up words 510.

FIG. 10B is a block diagram illustrating the memory 130 storing wake-up words 510, recommended commands 530, and recommended wake-up words 520. Referring to FIG. 10B, the memory 130 of the electronic device 101 may store obtained recommended commands 530. As an example, the electronic device 101 may match recommended wake-up words 520 to the recommended commands 530. The electronic device 101 may store the recommended commands 530 in the memory 130, and store the matching relationship between the recommended commands 530 and the recommended wake-up words 520. In FIG. 10B, the matching relationship between the recommended commands 530 and the recommended wake-up words 520 may indicate the straight lines connecting the recommended commands 530 and the recommended wake-up words 520.

In FIG. 10B, the client module 151 of the electronic device 101 when identifying a wake-up word 510 included in a voice input may operate in substantially the same manner as the client module 151 of the electronic device 101 when identifying a wake-up word 510 included in the voice input in FIG. 10A.

In FIG. 10B, when the client module 151 identifies a recommended command 530 included in the voice input, the electronic device 101 may perform an operation for speech recognition. For example, the electronic device 101 may transmit the voice input to the intelligent server 200 and receive a plan generated based on the recommended command 530 or the result of performing the plan from the intelligent server 200.

In FIG. 10B, when the client module 151 identifies a recommended wake-up word 520 included in the voice input, the electronic device 101 may perform an operation for speech recognition. As an example, when identifying the recommended wake-up word 520, the electronic device 101 may generate a plan based on a recommended command 530 corresponding to the recommended wake-up word 520.

For example, the electronic device 101 may generate the recommended command 530 corresponding to the identified recommended wake-up word 520 and transmit the recommended command 530 to the intelligent server 200. The intelligent server may generate a plan based on the recommended command 530. As another example, the intelligent server 200 may receive the recommended wake-up word 520 from the electronic device 101 and generate a plan based on the recommended wake-up word 520. As an example, the intelligent server 200 may receive the recommended wake-up word 520 from the electronic device 101 and match the recommended wake-up word 520 to a recommended command 530 and a plan. As an example, the intelligent server 200 may receive data regarding the matching relationship between the recommended wake-up word 520, the recommended command 530, and the plan from the electronic device 101.

As another example, the electronic device may input the recommended wake-up word 520 or the generated recommended command 530 into the natural language platform of the electronic device 101 to generate a plan according to the recommended command 530. As an example, the electronic device 101 may match the recommended wake-up word 520 to the recommended command 530 and the plan, and the natural language platform may generate the plan corresponding to the input recommended wake-up word 520.

As another example, the electronic device 101 may transmit the data corresponding to the recommended wake-up word 520 or recommended command 530 to the intelligent server 200. The data corresponding to the recommended wake-up word 520 or recommended command 530 transmitted to the intelligent server 200 may include data corresponding to at least one of the intent, parameters, domain, action, or concept necessary for the intelligent server 200 to generate the plan corresponding to the recommended command 530.

In FIG. 10B, when the electronic device 101 identifies a recommended wake-up word 520 “No. 1”, the electronic device 101 may generate a plan identical to that when identifying a recommended command 530 “Channel A”, for example, a plan corresponding to the recommended command 530 “Channel A”. When identifying the recommended wake-up word 520 “No. 1”, the electronic device 101 may operate according to the plan identical to that when identifying the recommended command 530 “Channel A”.

As an example, when a voice input including a recommended wake-up word 520 or a recommended command 530 is not received from the user within a preset time, the electronic device 101 may delete the recommended command 530 from the memory 130. In FIG. 10(B), at least one of the recommended commands 530 “Channel A”, “Channel B”, and “Channel C” and the recommended wake-up words 520 “No. 1”, “No. 2”, and “No. 3” is not input within the set time, the electronic device may delete the recommended commands 530 “Channel A”, “Channel B”, and “Channel C”, and the memory 130 may change to the state as in FIG. 10A.

Referring to FIG. 10C, the electronic device 101 according to various embodiments may match a plurality of recommended wake-up words 520 to a recommended command 530. As shown in FIG. 10C, the electronic device 101 may match recommended wake-up word 520 “No. 1” and “Red” to the recommended command 530 “Channel A”. In FIG. 10C, when identifying a recommended wake-up word 520 “No. 1” or “Red”, the electronic device 101 may generate a plan identical to that when identifying a recommended command 530 “Channel A”, for example, a plan corresponding to the recommended command 530 “Channel A”. When identifying the recommended wake-up word 520 “No. 1” or “Red”, the electronic device 101 may operate according to the plan identical to that when identifying the recommended command 530 “Channel A”.

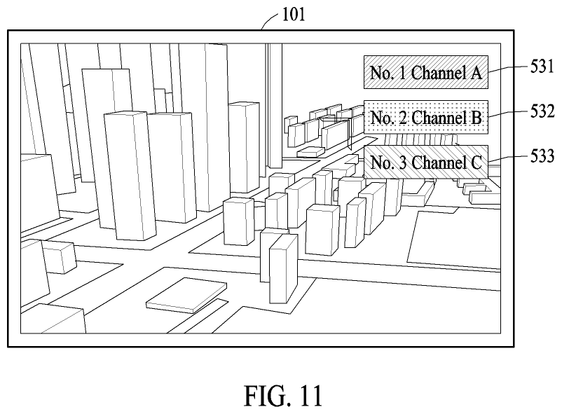

FIG. 11 is a diagram illustrating recommended wake-up words and recommended commands 531, 532, and 533 output to a display module (e.g., the display module 160 of FIG. 1) of an electronic device (e.g., the electronic device 101 of FIG. 1) according to an embodiment. FIG. 11 shows an example of outputting determined recommended commands and recommended wake-up words 531, 532, and 533 corresponding to the recommended commands to the display module 160 when domains of a plurality of plans (e.g., the plan 407 of FIG. 3) are identical as being related to applications (e.g., the plurality of apps 146 of FIG. 2) to change the channel of the electronic device 101, which is a TV. In FIG. 11, the recommended wake-up words and recommended commands 531, 532, and 533 may be output to the display module 160, each as a single object or icon by combining a recommended command and a recommended wake-up word corresponding to the recommended command.

In FIG. 11, the recommended commands and recommended wake-up words 531, 532, and 533 may be output to the display module 160 in different colors. For example, FIG. 11 shows an example of outputting, to the display module 160, the recommended command and recommended wake-up word 531 in red, the recommended command and recommended wake-up word 532 in blue, and the recommended command and recommended wake-up word 533 in green.

Referring to FIG. 11, the electronic device 101 according to various embodiments may output the recommended commands and recommended wake-up words 531, 532, and 533 to the display module 160. In FIG. 11, the recommended command and recommended wake-up word 531 may indicate the recommended command “Channel A” and recommended wake-up words “No. 1” and “Red”, the recommended command and recommended wake-up word 532 may indicate the recommended command “Channel B” and recommended wake-up words “No. 2” and “Blue”, and the recommended command and recommended wake-up word 533 may indicate the recommended command “Channel C” and recommended wake-up words “No. 3” and “Green”.

As shown in FIG. 11, the electronic device 101 may output the recommended commands and recommended wake-up words to the display module 160. The electronic device 101 may identify a recommended command or recommended wake-up word from a received voice input, and operate according to a plan generated based on the recommended command. For example, when identifying one of the recommended command “Channel A”, the recommended wake-up word “No. 1”, or the recommended wake-up word “Red” indicating the recommended command and recommended wake-up word 531 from the voice input, the electronic device 101 may change the channel to Channel A.

As an example, the electronic device 101 may identify a recommended command or recommended wake-up word, operate according to a plan generated based on the recommended command or the recommended command corresponding to the recommended wake-up word, and then change the recommended command and/or recommended wake-up word that is output to the display module 160.

For example, as in the example of FIG. 11, if the channel of the electronic device 101 is changed to Channel A according to the plan generated based on the recommended command “Channel A”, the recommended wake-up word “No. 1”, or the recommended wake-up word “Red”, the electronic device 101 may output, to the display module 160, a recommended command and recommended wake-up word (not shown) indicating “Channel D” and a recommended wake-up word “No. 4” or “Green”, instead of the recommended command and recommended wake-up word 531.

As an example, the electronic device 101 may change the matching relationship between the recommended commands and the recommended wake-up words output to the display module 160. In the above example, after changing the channel of the electronic device 101 to Channel A, the electronic device 101 may change the matching relationship between the recommended commands and the recommended wake-up words, so that the recommended command “Channel D” may be matched to the recommended wake-up word “No. 1” and “Red”.

As an example, the electronic device 101 may output the recommended commands and recommended wake-up words to the display module 160, considering the new matching relationship between the recommended commands and the recommended wake-up words. For example, the electronic device 101 may change the channel to Channel A according to the voice input, and then output the recommended command and recommended wake-up word 531 indicating the recommended command “Channel D” and the recommended wake-up words “No. 1” and “Red” to the display module 160.

The recommended wake-up words shown in FIGS. 10A, 10B, 10C, and 11 correspond to one of various embodiments, and recommended wake-up words different from the recommended wake-up words shown in FIGS. 10 and 11 may be set. For example, recommended wake-up words such as “ga”, “na”, “da”, “A”, “B”, and “C” may be set and stored in a memory (e.g., the memory 130 of FIG. 1) of the electronic device.

According to various embodiments, the electronic device 101 may set the recommended wake-up words so that the recommended wake-up words may be recognized with a high recognition rate by a client module (e.g., the client module 151 of FIG. 1). Recognizing the recommended wake-up words with a high recognition rate may indicate that the recommended wake-up words are pronounced differently so that the electronic device may recognize the recommended wake-up words without confusion.

For example, if the recommended wake-up words are “A”, “B”, and “C”, the recommended wake-up words may be identified from voice inputs that are pronounced as “ei”, “bi”, and “si”, respectively, and if the recommended wake-up words are “No. 1”, “No. 2”, and “No. 3”, the recommended wake-up words may be identified from voice inputs that are pronounced as “il beon”, “i beon”, and “sam beon”, respectively. While the recommended wake-up words “A”, “B”, and “C” are pronounced differently, the recommended wake-up words “No. 1”, “No. 2”, and “No. 3” may be likely to be confusing in recognizing the recommended wake-up words because “il” and “i” are pronounced similarly.

For example, when “il beon” is uttered, it may be recognized as the recommended wake-up word “No. 2”, or vice versa. The electronic device may be set considering the recognition rate of the recommended wake-up words.

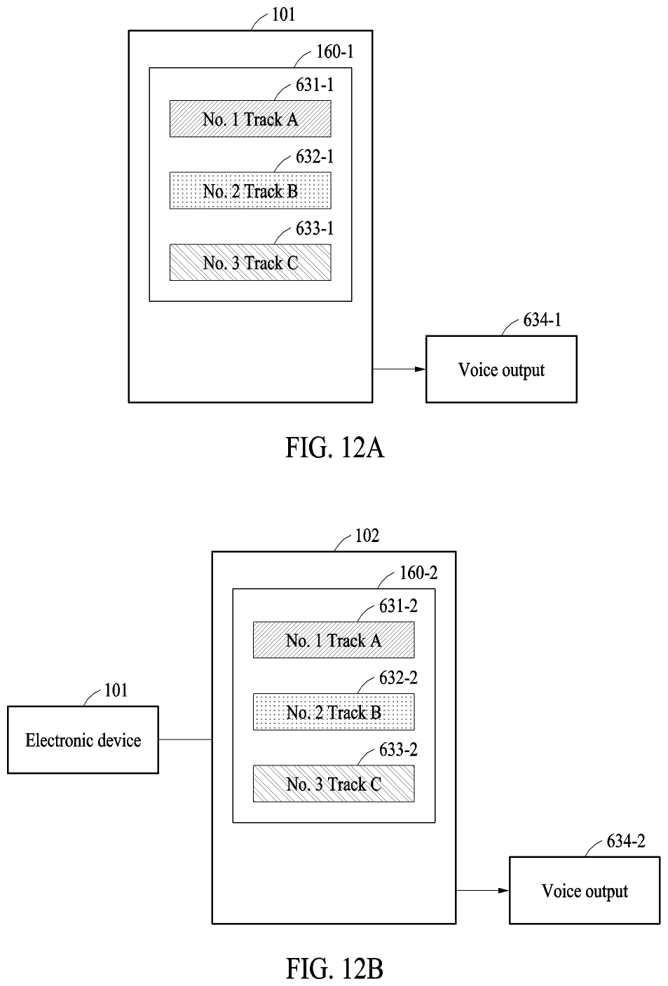

FIGS. 12A and 12B are diagrams illustrating recommended wake-up words and recommended commands 631-1, 632-1, 633-1, 631-2, 632-2, and 633-3 output to the display module 160 of the electronic device 101 or a display module 160-2 of the external electronic device 102 according to an embodiment. FIG. 12 shows an example of outputting determined recommended commands and recommended wake-up words 631-1, 632-1, 633-1, 631-2, 632-2, and 633-3 corresponding to the recommended commands to the display module 160, when domains of a plurality of plans (e.g., the plan 407 of FIG. 3) are identical as being related to applications (e.g., the plurality of apps 146 of FIG. 2) to change audio data being played on the electronic device 101 for playing music, such as an AI speaker. In FIGS. 12A and 12B, the recommended wake-up words and recommended commands 631-1, 632-1, 633-1, 631-2, 632-2, and 633-3 may be output to the display module 160, each as a single object or icon by combining a recommended command and a recommended wake-up word corresponding to the recommended command.

Referring to FIGS. 12A and 12B, the electronic device 101 according to various embodiments may output the recommended commands and recommended wake-up words 631-1, 632-1, 633-1, 631-2, 632-2, and 633-3 to the display module 160. In FIGS. 12A and 12B, the recommended command and recommended wake-up word 631 may indicate the recommended command “Track A” and recommended wake-up words “No. 1” and “Red”, the recommended command and recommended wake-up word 632 may indicate the recommended command “Track B” and recommended wake-up words “No. 2” and “Blue”, and the recommended command and recommended wake-up word 633 may indicate the recommended command “Track C” and recommended wake-up words “No. 3” and “Green”.

In FIG. 12A, the electronic device 101 may output the recommended commands and recommended wake-up words to the display module 160. The electronic device 101 may identify a recommended command or recommended wake-up word from a received voice input, and operate according to a plan generated based on the recommended command. For example, when identifying one of the recommended command “Track A”, the recommended wake-up word “No. 1”, or the recommended wake-up word “Red” indicating the recommended command and recommended wake-up word 631-1 from the voice input, the electronic device 101 may change the audio data being played to Track A and play Track A.

As an example, the electronic device 101 may output the recommended commands and recommended wake-up words 631-1, 632-1, and 633-1 as a voice output 634-1. For example, the electronic device 101 may output a voice such as “No. 1, Track A, No. 2, Track B, No. 3, Track C” using a sound output module (e.g., the sound output module 155 of FIG. 1).

FIG. 12B is a diagram illustrating recommended commands and recommended wake-up words 631-2, 632-2, and 633-2 output to the display module 160-2 of the external electronic device 102 coupled to the electronic device 101.

In FIG. 12B, the electronic device 101 may operate in substantially the same manner as in FIG. 12A. For example, the electronic device 101 may output the recommended commands and recommended wake-up words 631-2, 632-2, and 633-2 to the display module 160-2 of the external electronic device 102 coupled to the electronic device 101. The electronic device 101 may identify a recommended command or recommended wake-up word from a received voice input, and operate according to a plan generated based on the recommended command. For example, when the electronic device 101 identifies one of the recommended command “Track A”, the recommended wake-up word “No. 1”, or the recommended wake-up word “Red” indicating the recommended command and recommended wake-up word 631-2 from the voice input, the external electronic device 102 may change the audio data being played to Track A and play Track A.

As an example, the electronic device 101 may output the recommended commands and recommended wake-up words 631-2, 632-2, and 633-2 as the voice output 634-1 using the external electronic device 102. For example, the electronic device 101 may output a voice such as “No. 1, Track A, No. 2, Track B, No. 3, Track C” using a sound output module (e.g., the sound output module 155 of FIG. 1) of the external electronic device 102.

The description provided with reference to FIG. 11 may apply substantially identically to the electronic device 101 shown in FIGS. 12A and 12B, even if the description is not provided with reference to FIGS. 12A and 12B. For example, in FIGS. 12A and 12B, the electronic device 101 may change the matching relationship between the recommended commands and the recommended wake-up words output to the display module 160. For example, the electronic device 101 may perform an operation, for example, playing Track A based on a plan generated according to the voice input, and the electronic device 101 may change the matching relationship between the recommended commands and the recommended wake-up words, so that the recommended command “Track D” may be matched to the recommended wake-up word “No. 1” and “Red”.

In the above examples, examples in which the electronic device is a TV or an audio playback device and a plurality of plans are plans for channel change or plans to change audio data being played, but the examples correspond to one of various embodiments. For example, the same description may apply to various embodiments in which the electronic device is a TV and the plurality of plans are plans other than the plans for channel change, such as embodiments in which the plurality of plans are plans for volume control, control functions such as brightness or contrast control, or image search using an application provided by the electronic device. As another example, the same description may apply to various embodiments in which the electronic device is an audio playback device and the plurality of plans are not plans to change audio data being played, such as embodiments in which the plurality of plans are music search, artist search, or plans for volume control.

In the above examples, cases where the electronic device is a TV or an audio playback device have been described, but the electronic device to which the above examples are applicable is not limited to a TV or an audio playback device, and the above description may apply identically to an electronic device such as a smart phone, a tablet, or a laptop, other than a TV or an audio playback device.

An electronic device 101 according to various embodiments may include a processor 120, an input module 150 configured to receive a voice input from a user, and a memory 130 electrically connected to the processor 120 and configured to store a recommended command, a client module 151, and instructions executable by the processor 120, wherein the processor 120 may, when the instructions are executed, determine whether domains of a plurality of plans (e.g., the plan 407 of FIG. 3) consecutively generated according to a command included in the voice input are identical by a preset number or more, store the recommended command obtained based on the domains in the memory 130, when the domains are identical by the preset number or more, and control the client module 151 to be executed based on a plan generated according to the recommended command.

The client module 151 may generate the plan corresponding to the voice input when identifying the recommended command or a wake-up word preceding the command included in the voice input.

The memory 130 may store information about the user, and the processor 120 may identify the user using the voice input, and obtain the recommended command based on the information about the user and the domain.

The processor 120 may delete the recommended command stored in the memory 130 when the recommended command is not input from the user within a preset time.

The processor 120 may match the recommended command to a recommended wake-up word, and the client module 151 may identify the recommended wake-up word included in the voice input, and generate the plan according to the recommended command corresponding to the recommended wake-up word.

The processor 120 may output the recommended command and the recommended wake-up word to a display module 160.

The electronic device 101 may further include a natural language platform 220 configured to process the voice input and generate the plan.

The processor 120 may determine whether the user who utters the voice input including the command is identical to a user who utters a voice input including the recommended command.

An electronic device 101 according to various embodiments may include a processor 120, an input module 150 configured to receive a voice input from a user, and a memory 130 electrically connected to the processor 120 and configured to store a recommended command, a client module 151, and instructions executable by the processor 120, wherein the client module 151 may generate a plan according to the voice input when identifying the recommended command or identifying a wake-up word to start speech recognition from the voice input, and the processor 120 may, when the instructions are executed, determine whether domains of plans consecutively generated according to a command following the wake-up word included in the voice input are identical by a preset number or more, store the recommended command related to a predicted utterance of the user in the memory 130, when the domains are identical by the preset number or more, and control the client module 151 to be executed based on a plan generated according to the recommended command.

The memory 130 may store information about the user, and the processor 120 may identify the user using the voice input, and obtain the recommended command based on the information about the user and the domain.

The processor 120 may delete the recommended command stored in the memory 130 when the recommended command is not input from the user within a preset time.

The processor 120 may match the recommended command to a recommended wake-up word, and the client module 151 may identify the recommended wake-up word included in the voice input, and generate the plan according to the recommended command corresponding to the recommended wake-up word.

The processor 120 may output the recommended command and the recommended wake-up word to a display module 160.

The electronic device 101 may further include a natural language platform 220 configured to process the voice input and generate the plan.

The processor 120 may determine whether the user who utters the voice input including the command is identical to a user who utters a voice input including the recommended command.

An electronic device 200 according to various embodiments may include a front end 210 configured to receive a voice input from a user terminal and transmit a response corresponding to the voice input to the user terminal 101, and a natural language platform 220 configured to process the voice input and generate a plan corresponding to the voice input, wherein the natural language platform 220 may determine whether domains of plans consecutively generated are identical by a preset number or more, and store a recommended command obtained based on the domains when the domains are identical by the preset number or more, and the user terminal 101 may transmit the voice input to the front end 210 when the voice input includes a wake-up word to start speech recognition or the recommended command.

The natural language platform 220 may match the recommended command and a plan according to the recommended command, and generate a plan according to the recommended command when the recommended command is input.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method According to an embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
an input module configured to receive a voice input from a user;
a memory storing instructions; and
a processor configured to execute the instructions to:
determine whether domains of a plurality of plans consecutively generated according to a command included in the voice input are identical by a preset number or more,
store a recommended command obtained based on the domains in the memory, when the domains are identical by the preset number or more, and
control a client module to be executed based on a plan generated according to the recommended command.

2. The electronic device of claim 1, wherein the client module is configured to generate the plan corresponding to the voice input when identifying the recommended command or a wake-up word preceding the command included in the voice input.

3. The electronic device of claim 1, wherein
the processor is configured to execute the instructions to identify the user using the voice input, and obtain the recommended command based on information about the user and the domains.

4. The electronic device of claim 1, wherein the processor is configured to execute the instructions to delete the stored recommended command when the recommended command is not input from the user within a preset time.

5. The electronic device of claim 1, wherein
the processor is configured to execute the instructions to match the recommended command to a recommended wake-up word, and the client module is configured to identify the recommended wake-up word included in the voice input, and generate the plan according to the recommended command corresponding to the recommended wake-up word.

6. The electronic device of claim 5, wherein the processor is configured to execute the instructions to output the recommended command and the recommended wake-up word to a display module.

7. The electronic device of claim 1, further comprising:
a natural language platform configured to process the voice input and generate the plan.

8. The electronic device of claim 1, wherein the processor is configured to execute the instructions to determine whether the user who utters the voice input comprising the command is identical to a user who utters a voice input comprising the recommended command.

9. An electronic device comprising:
an input module configured to receive a voice input from a user;
a client module configured to generate a plan according to the voice input when identifying a recommended command or identifying a wake-up word to start speech recognition from the voice input, and
a processor is configured to:
determine whether domains of plans consecutively generated according to a command following the wake-up word included in the voice input are identical by a preset number or more,
store the recommended command related to a predicted utterance of the user, when the domains are identical by the preset number or more, and
control the client module to be executed based on the plan generated according to the recommended command.

10. The electronic device of claim 9, wherein the processor is configured to identify the user using the voice input, and obtain the recommended command based on information about the user and the domains.

11. The electronic device of claim 9, wherein the processor is configured to delete the stored recommended command when the recommended command is not input from the user within a preset time.

12. The electronic device of claim 9, wherein
the processor is configured to match the recommended command to a recommended wake-up word, and
the client module is configured to identify the recommended wake-up word included in the voice input, and generate the plan according to the recommended command corresponding to the recommended wake-up word.

13. The electronic device of claim 12, wherein the processor is configured to output the recommended command and the recommended wake-up word to a display module.

14. An electronic device comprising:
a front end configured to receive a voice input from a user terminal and transmit a response corresponding to the voice input to the user terminal; and
a natural language platform configured to process the voice input and generate a plan corresponding to the voice input, wherein
the natural language platform is configured to determine whether domains of plans consecutively generated are identical by a preset number or more, and store a recommended command obtained based on the domains when the domains are identical by the preset number or more, and
the user terminal is configured to transmit the voice input to the front end when the voice input comprises a wake-up word to start speech recognition or the recommended command.

15. The electronic device of claim 14, wherein the natural language platform is configured to match the recommended command and a plan according to the recommended command, and generate a plan according to the recommended command when the recommended command is input.
